(19) United States
(12) Patent Application Publication
(10) Pub. No.: US 2026/0111548 A1
(43) Pub. Date: Apr. 23, 2026

(54) Cybersecurity Detection Grouping

(71) Applicant: CrowdStrike, Inc., Sunnyvale, CA (US)

(72) Inventors: Ryan Inghilterra, Carlsbad, CA (US); Michael Avraham Brautbar, Wayland, MA (US)

(73) Assignee: CrowdStrike, Inc., Sunnyvale, CA (US)

(21) Appl. No.: 18/922,066

(22) Filed: Oct. 21, 2024

(51) Int. Cl. G06F 21/56; G06F 21/55

(52) U.S. Cl. CPC G06F 21/566; G06F 21/554

(57) ABSTRACT

A cybersecurity service assesses cybersecurity detections reported by endpoint client devices. The cybersecurity detections are compared to different groupings of historical cybersecurity detections. Each grouping of the historical cybersecurity detections shares common traits, features, and other characteristics. As each new cybersecurity detection is received, the cybersecurity service determines the best match between the new cybersecurity detection and the different groupings of the historical cybersecurity detections, based on similar traits, features, and other characteristics. The cybersecurity service may thus commonly assess the new cybersecurity detection based on the best match.

### BACKGROUND

The subject matter described herein generally relates to computers and, more particularly, the subject matter relates to computer system security.

Cybersecurity threats are always increasing. Every day, a cybersecurity service provider may receive thousands of reports of viruses, hacks, and other suspicious computer behavior. These cybersecurity detections are often analyzed and assessed by human experts. Needless to say, human assessment requires great skill and much time. As the volume of cybersecurity threats is always increasing, the human experts need tools that quickly identify and help resolve cybersecurity threats.

### SUMMARY

A digital cybersecurity service assesses new cybersecurity detections associated with client devices. The new cybersecurity detections are compared to different groupings of historical cybersecurity detections. Each grouping of the historical cybersecurity detections shares common traits, features, and other characteristics. Each grouping of the historical cybersecurity detections, for example, is associated with a corresponding detection intersection. As each new cybersecurity detection is received, the cybersecurity service determines the best group match(es), based on a similarity of the new cybersecurity detection to the detection intersections associated with the different groupings of the historical cybersecurity detections. Once the best group match/matches is/are determined, the cybersecurity service may quickly assess the new cybersecurity detection. Because the new cybersecurity detection commonly shares the traits, features, and other characteristics of the best group match(es), the cybersecurity service may apply the same cybersecurity analysis, recommendation, and remediation. The cybersecurity service may further apply natural language processing that simply explains the new cybersecurity detection and its group membership traits using generalized words and phrases that are much easier for human users to understand.

### BRIEF DESCRIPTION OF THE SEVERAL VIEWS OF THE DRAWINGS

The features, aspects, and advantages of cybersecurity detection grouping are understood when the following Detailed Description is read with reference to the accompanying drawings, wherein:

FIGS. 1-4 illustrate some examples of assessing potential cybersecurity threats reported by endpoint clients;

FIGS. 5-6 illustrate examples of a detection assessment;

FIGS. 7-8 illustrate examples of cybersecurity detection grouping;

FIGS. 9-10 illustrate examples of a similarity analysis;

FIGS. 11-14 illustrate more examples of cybersecurity detection grouping;

FIG. 15 illustrates examples of SIEM data field weightings;

FIGS. 16-18 illustrates examples of streaming-based approaches;

FIG. 19 illustrates examples of a hybrid clustering+similarity operation;

FIGS. 20-21 illustrate examples of a detection summary;

FIG. 22 illustrates examples of host monitoring;

FIGS. 23-24 illustrate examples of methods or operations that assess cybersecurity detections; and

FIG. 25 illustrates a more detailed example of an operating environment.

### DETAILED DESCRIPTION

Some examples relate to detection and assessment of abnormal, suspicious, or even malicious computer activities, behaviors, and usage. As we know, nearly every day we read of another network hack, computer virus, or other cybersecurity threat. To stop these cybersecurity threats, many prudent computer users subscribe to a cybersecurity service. The cybersecurity service monitors smartphones, laptops, servers, or other client devices for cybersecurity threats. When the cybersecurity service detects unusual computer activity, the cybersecurity service conducts a deeper analysis. Because so many prudent computer users rely on the cybersecurity service, each day the cybersecurity service may receive hundreds of cybersecurity detections sent from protected client devices. Each cybersecurity detection describe some unusual computer activity that needs investigating. As one may understand, these hundreds of daily cybersecurity detections can overwhelm computer and human resources.

The cybersecurity service, though, conducts an automated detection assessment. Because the cloud service may receive hundreds of daily cybersecurity detections, the cybersecurity service performs an elegant, initial assessment of each cybersecurity detection. The cybersecurity service conducts a sophisticated clustering analysis and similarity analysis to quickly summarize each cybersecurity detection. That is, the cybersecurity service compares each cybersecurity detection to different groupings of historical, previously-received cybersecurity detections. If a newly-received cybersecurity detection is sufficiently similar to a grouping, then the newly-received cybersecurity detection must share the same or similar features, traits, values, and other characteristics. Because the newly-received cybersecurity detection can be considered a member of the group, then the newly-received cybersecurity detection may be automatically assessed and summarized as other members of the same group. Group membership may thus be used to quickly and simply preprocess the hundreds of daily cybersecurity detections.

Cybersecurity detection grouping will now be described more fully hereinafter with reference to the accompanying drawings. Cybersecurity detection grouping, however, may be embodied in many different forms and should not be construed as limited to the examples set forth herein. These examples are provided so that this disclosure will be thorough and complete and fully convey cybersecurity detection grouping to those of ordinary skill in the art. Moreover, all the examples of cybersecurity detection grouping are intended to encompass both structural and functional equivalents thereof. Additionally, it is intended that such equivalents include both currently known equivalents as well as equivalents developed in the future (i.e., other elements developed that perform the same function, regardless of structure).

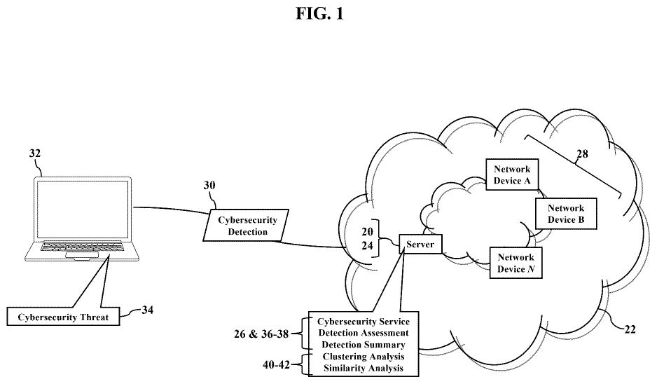

FIGS. 1-4 illustrate some examples of assessing potential cybersecurity threats reported by, or otherwise associated with, endpoint clients. A computer system 20 operates in a cloud computing environment 22. FIG. 1 illustrates the computer system 20 as a server 24. The computer system 20, though, may be another processor-controlled device, as later paragraphs will explain. The cloud computing environment 22 provides a digital cybersecurity service 26 on behalf of a service provider. The server 24 helps provide the digital cybersecurity service 26. In this example, the server 24 communicates via the cloud computing environment 22 (e.g., public Internet, private network, and/or hybrid network) with other servers, devices, computers, or other networked members 28 that also help provide the cybersecurity service 26. The server 24, for example, is programmed to assess and to explain a cybersecurity detection 30 (or sometimes referred to as a cybersecurity alert) associated with an endpoint client device 32. That is, when the client device 32 detects suspicious behavior, unusual login/location context, or other potential cybersecurity threat 34, the client device 32 generates and sends the cybersecurity detection 30 to a network address (e.g., IP address) associated with the cloud computing environment 22. When the cloud computing environment 22 receives the cybersecurity detection 30, the networked members 28 may be programmed to forward the cybersecurity detection 30 to the server 24.

The server 24 provides an initial, preliminary assessment of the cybersecurity detection 30. When the server 24 receives the cybersecurity detection 30, the server 24 conducts a detection assessment 36. The cybersecurity detection 30 may be complicated, so the cybersecurity detection 30 may conventionally require perhaps hours of human analysis. Here, though, the server 24 quickly and elegantly generates a detection summary 38 of the cybersecurity detection 30. The server 24, in particular, may generate the detection summary 38 based on an elegant clustering analysis 40 and an elegant similarity analysis 42, which later paragraphs will explain. The detection summary 38, in particular, explains the complicated cybersecurity detection 30, perhaps using generalized words and phrases that are very easy for human users to understand. Moreover, the server 24 may generate the detection summary 38 in near real time (such as within seconds or minutes), thus greatly improving response times for mitigating the cybersecurity threat 34.

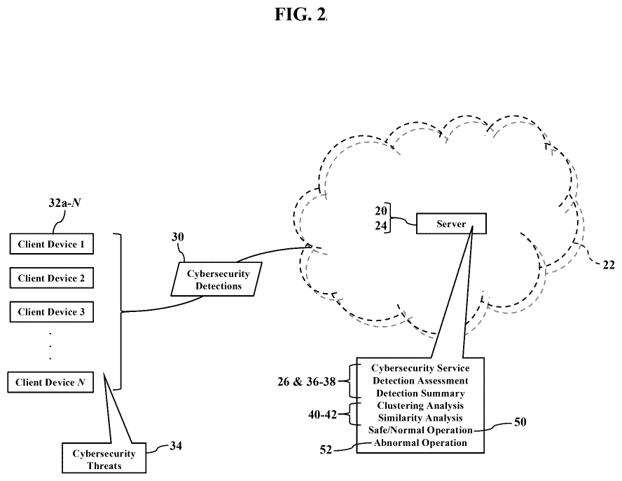

As FIG. 2 illustrates, the cloud computing environment 22 may receive thousands of the cybersecurity detections 30. The cloud computing environment 22 may interface with many different endpoint client devices (illustrated as reference numerals 32a-N) operating in the field. Indeed, there may be thousands or even millions of the client devices 32a-N subscribing to the digital cybersecurity service 26. These many client devices 32a-N often detect potential cybersecurity threats 34, so each week the cloud computing environment 22 may receive thousands of the cybersecurity detections 30. When the cloud computing environment 22 receives streams of the many cybersecurity detections 30, the cybersecurity service 26 may assess and screen each cybersecurity detection 30 as safe/normal operation 50 or as an abnormal operation 52, again using the clustering analysis 40 and the similarity analysis 42 (i.e., the clustering+similarity detection assessment 36). As one may now understand, then, the cloud computing environment 22 must manage the ever-increasing volume of the cybersecurity detections 30 reported in near real time by the client devices 32.

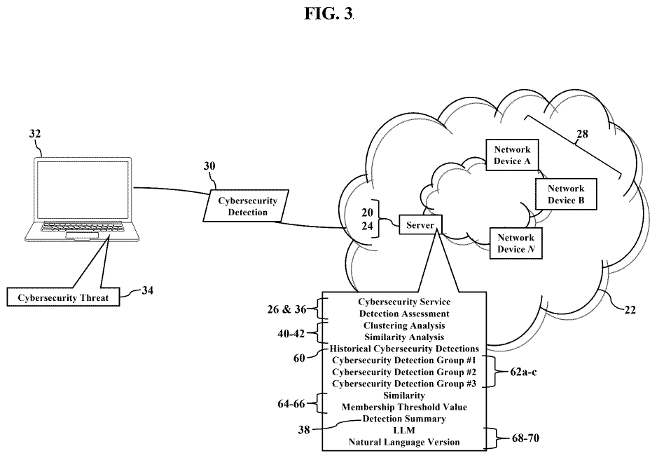

FIG. 3 illustrates examples of the detection assessment 36. When the client device 32 detects suspicious computer activity, behavior, context, or other potential cybersecurity threat 34, the client device 32 generates and sends the cybersecurity detection 30. The cybersecurity detection 30 includes or references data representing the cybersecurity threat 34 detected at the endpoint client device 32. The data representing the cybersecurity threat 34, for example, may be metadata representing or describing the suspicious behavior, unusual login/location context, suspicious website or webpage, unusual or suspicious events/processes, keystrokes/inputs, or other potential cybersecurity risk. Whatever data is reported, the cybersecurity detection 30 alerts or notifies the cloud computing environment 22 that the client device 32 has detected the potential cybersecurity threat 34. The client device 32, in other words, has detected a program, process, communication, behavior, location, or some other evidence that may indicate suspicious/malicious activity (such as malicious behavior, usage, or software/malware). When the cloud computing environment 22 receives the cybersecurity detection 30, the networked members 28 route the cybersecurity detection 30 to the server 24. The server 24 is programmed to conduct deep, near real time analysis of the cybersecurity detection 30 and perhaps even generate a recommendation and remediation.

The detection assessment 36 may use the clustering analysis 40. The server 24, for example, applies the clustering analysis 40 to historical cybersecurity detections 60 collected over time (such as daily, weekly, monthly, or other time period). The clustering analysis 40 generates different groupings of the historical cybersecurity detections 60. The clustering analysis 40, for example, generates one or more cybersecurity detection groups 62. Each cybersecurity detection group 62 is associated with common membership features, traits, or characteristics. The members of each cybersecurity detection group 62 share the same or similar features, traits, or characteristics. FIG. 3, for example, illustrates a simple example of three (3) different cybersecurity detection groups (illustrated as reference numerals 62a-c). In actual, real world practice, though, there may be hundreds or more of different cybersecurity detection groups 62. When the server 24 receives the new/recent cybersecurity detection 30, the server 24 compares the cybersecurity detection 30 to the cybersecurity detection groups 62. The server 24 determines if the cybersecurity detection 30 shares the same or similar membership characteristics to one, or more, of the cybersecurity detection groups 62.

The detection assessment 36 may use the similarity analysis 42. The server 24 compares the cybersecurity detection 30 to the cybersecurity detection groups 62 using the similarity analysis 42. The server 24, for example, determines a similarity 64 of the cybersecurity detection 30 to each one of the cybersecurity detection groups 62. The server 24 may then compare the similarity 64 to a membership threshold value 66. If the similarity 64 equals or exceeds the threshold value 66, then the server 24 generates a prediction that the cybersecurity detection 30 is a member of the corresponding cybersecurity detection group 62. If, however, the similarity 64 fails to satisfy (i.e., is less than) the membership threshold value 66, then the server 24 predicts that the cybersecurity detection 30 is not a member of the corresponding cybersecurity detection group 62.

Once groupal membership is determined, the server 24 may generate the detection summary 38. When the cybersecurity detection 30 is predicted to be a member of the cybersecurity detection group 62, the server 24 may generate the detection summary 38 of the cybersecurity detection 30, based on its membership to the cybersecurity detection group(s) 62. That is, because the cybersecurity detection 30 has the minimum or adequate similarity 64 to the cybersecurity detection group 62, the cybersecurity detection 30 shares, or is similar to, the common membership features/traits/characteristics associated with the cybersecurity detection group 62. The server 24 may thus add, assign, or associate the same groupal membership features/traits/characteristics to the cybersecurity detection 30. The detection summary 38 may thus be based on the common membership features/traits/characteristics that are shared by the members of the cybersecurity detection group 62. The detection summary 38 explains the complicated cybersecurity detection 30, based on the common membership features/traits associated with the cybersecurity detection group 62.

The server 24 may apply natural language processing. Once the server 24 determines the cybersecurity detection group 62, and the features/traits/characteristics that are shared by the members of the cybersecurity detection group 62, the server 24 generates the detection summary 38. The detection summary 38 describes the cybersecurity detection 30, the cybersecurity detection group 62, and the shared or common features/traits/characteristics. The detection summary 38, may be highly technical and very complicated. The server 24, then, may further apply, or interface with, a large language model (or LLM) 68 that generates a natural language version 70 of the detection summary 38. The large language model 68, in other words, may output simple, generalized words and phrases that describe and explain the cybersecurity detection 30, the cybersecurity detection group 62, and/or the shared or common features/traits/characteristics. The natural language version 70 of the detection summary 38 is thus much easier for human users to understand.

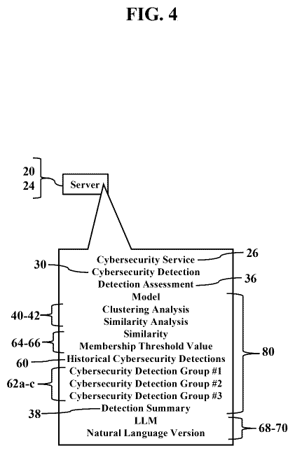

FIG. 4 illustrates examples of machine learning and/or artificial intelligence applied to the detection assessment 36. The server 24 may apply, or interface with, an ML/AI model 80 that analyzes the cybersecurity detection 30 and that conducts the detection assessment 36. The model 80 is trained to program the server 24 to generate the different cybersecurity detection groups 62 of the historical cybersecurity detections 60 by applying the clustering analysis 40 and the similarity analysis 42 (i.e., the clustering+similarity detection assessment 36). FIG. 4 again illustrates a simple example of three (3) different cybersecurity detection groups (illustrated as reference numerals 62a-c). In actual, real world practice, though, there may be hundreds or more of different cybersecurity detection groups 62. When the server 24 receives the new/recent cybersecurity detection 30, the server 24 compares the cybersecurity detection 30 to the cybersecurity detection groups 62. The server 24 determines if the cybersecurity detection 30 shares the same or similar membership characteristics to one, or more, of the cybersecurity detection groups 62. The model 80, for example, determines the similarity 64 of the cybersecurity detection 30 to each one of the cybersecurity detection groups 62. The model 80 may then compare the similarity 64 to the membership threshold value 66. If the similarity 64 equals or exceeds the minimum threshold value 66, then the model 80 generates the groupal membership prediction with the corresponding cybersecurity detection group 62. Once groupal membership is determined, the model 80 causes the server 24 to generate the detection summary 38, based on its membership to the cybersecurity detection group(s) 62. The detection summary 38 reflects the common membership features/traits/characteristics that are shared by the members of the cybersecurity detection group 62. However, because the detection summary 38 may be complicated, the model 80 may instruct the server 24 to apply, or interface with, the large language model (or LLM) 68 that generates the natural language version 70 of the detection summary 38. The large language model 68 may output the natural language version 70 of the detection summary 38 that is thus much easier for human users to understand.

The detection assessment 36 improves the digital cybersecurity service 26. Because the cybersecurity service 26 may receive thousands of the cybersecurity detections 30, human cybersecurity experts are often overwhelmed. The detection assessment 36, though, quickly and elegantly generates the detection summary 38 using the clustering analysis 40 and the similarity analysis 42 (i.e., the clustering+similarity detection assessment 36). The detection assessment 36 provides contextual enrichment, which assists human cybersecurity analysts in quickly finding information they need to assess and to adjudicate the cybersecurity detections 30. The detection assessment 36 minimizes user-load and time-to-action by identifying collections of related cybersecurity detections 30 (i.e., the cybersecurity detection group 62). Because the cybersecurity detection group 62 includes semantically-related and/or highly-correlated cybersecurity detections 30, the detection assessment 36 makes human assessment and adjudication much easier and far faster. Moreover, the clustering+similarity detection assessment 36 provides a level of interpretability as to why cybersecurity detections 30 are grouped together. The clustering+similarity detection assessment 36 may also feed the cybersecurity detections 30 and the cybersecurity detection group 62 into the large language model 68 for advanced summarization and explainability.

The detection assessment 36 further improves the digital cybersecurity service 26. The detection assessment 36 automates a correlation of the cybersecurity detection 30 to the cybersecurity detection group 62, using the similarity analysis 42. The digital cybersecurity service 26 (such as a security information and event management system or SIEM) collects and aggregates logs from various sources. The ML/AI-based clustering+similarity detection assessment 36 may automatically correlate the cybersecurity detections 30 across diverse data sources (such as, for example, first and third party alerts), thus helping construct a coherent narrative of a cybersecurity attack. The clustering+similarity detection assessment 36 thereby aids in faster and more accurate incident response.

The clustering+similarity detection assessment 36 also provides enhanced customization and contextualization. Because the detection assessment 36 generates the detection summary 38, the detection summary 38 may be customized to suit style, content, and performance objectives. That is, once the cybersecurity detection 30 is grouped/clustered to the cybersecurity detection group(s) 62, the detection assessment 36 may add, augment, or associate the detection summary 38 to the cybersecurity detection 30. The detection summary 38 provides valuable contextual and summarized information on the cybersecurity detection group(s) 62. The detection summary 38, for example, may identify the actual similarities 64 between the cybersecurity detections 30 and the members of the cybersecurity detection group 62. Groupal membership characteristics may be fed as inputs into the large language model 68, and the large language model 68 may generate the natural language version 70 of the detection summary 38. The natural language version 70 of the detection summary 38, in other words, summarizes and contextualizes the cybersecurity detection 30 and/or the membership characteristics of the cybersecurity detection group 62 in a way that is very helpful to an end-user (such as a human cybersecurity expert analyst, a system operations center, or other cybersecurity personnel). Indeed, the detection assessment 36 may be configured and customized to allow end SOC analysts control over what type of cybersecurity detections 30 and alert fields to use when grouping.

The inventors have thus designed, built, and trained the model 80 for a particular solution to a particular problem. Malware is a problem in computing systems and in computer networks. As we all know, nearly every day there is another hack that steals account passwords, business data, and personal information. Email inboxes often contain phishing emails, malicious website links, and virus attachments. Text messages may also contain malicious links and content. Indeed, hackers are always trying new schemes to steal information. The digital cybersecurity service 26, though, customizes and tailors the model 80 to particularly identify the similar groupings 62 of normal and abnormal computer operation 50/52. The model 80, in particular, identifies and describes cybersecurity detections 30 that represent suspicious/maliciousness/abnormal computer operation 52. The inventors have designed, built, and trained the model 80 as a significant contribution to computer behavioral prediction and to potential malware detection.

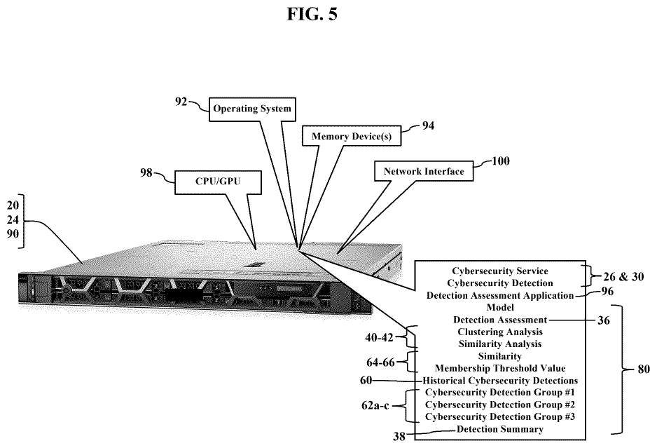

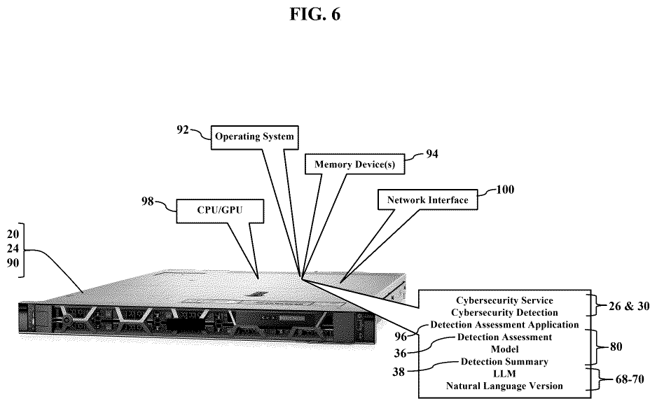

FIGS. 5-6 illustrate more detailed examples of the detection assessment 36. FIG. 5 illustrates the server 24 as a rack server 90, which is commonly installed in server farms and server rooms. The server 24/90 is programmed to provide the detection assessment 36 as a component or sub-service of the digital cybersecurity service 26. The server 24/90 stores and executes an operating system 92 in a memory device 94. The server 24/90 also stores a detection assessment application 96 in the memory device 94. The server 24/90 has a hardware processor with cores 98 (illustrated as “CPU/GPU”) that reads and executes the operating system 92 and the detection assessment application 96. The server 24/90 also has network interfaces 100 to multiple communications networks (such as the cloud computing environment 22 illustrated in FIGS. 1-3), thus allowing bi-directional communications with other networked devices and services. When the server 24/90 receives the cybersecurity detection 30, the detection assessment application 96 may be a computer program, instruction(s), or code that instructs or causes the server 24 to preliminarily assess and summarize the cybersecurity detection 30.

The server 24/90 is programmed to perform the detection assessment 36. The detection assessment application 96 instructs or causes the hardware processor 98 to perform operations, such as applying the machine learning and/or the artificial intelligence (such as the model 80) to determine the similarity 64 of the cybersecurity detection 30 to the cybersecurity detection group(s) 62. Again, while FIG. 5 only illustrates the three (3) cybersecurity detection groups 62a-c, in actual practice there may be hundreds or more groupings having rich and/or diverse membership features, traits, characteristics, and/or dimensions. The members of each cybersecurity detection group 62 thus share the same or similar features/traits/characteristics/dimensions. The detection assessment application 96 may also instruct or cause the server 24/90 to compare the similarity 64 to the membership threshold value 66 associated with each cybersecurity detection group 62. If the similarity 64 is less than the membership threshold value 66, then perhaps the cybersecurity detection 30 lacks the required/requisite/minimum affinity with the corresponding cybersecurity detection group 62. The detection assessment application 96 may thus instruct or cause the server 24/90 to determine the cybersecurity detection 30 is not similar to, and thus not a member of, the cybersecurity detection group 62. If, however, the similarity 64 is equal to or exceeds the membership threshold value 66, then the cybersecurity detection 30 exhibits or possesses the required/requisite/minimum affinity/association with the cybersecurity detection group 62. The detection assessment application 96 may thus instruct or cause the server 24/90 to determine the cybersecurity detection 30 is similar to, and thus is a member of, the cybersecurity detection group 62.

The server 24/90 may summarize the detection assessment 36. Because the similarity 64 satisfies the membership threshold value 66, the detection assessment application 96 caused the server 24/90 to associate the cybersecurity detection 30 as a member of the cybersecurity detection group 62. The cybersecurity detection 30 may thus share the same features, traits, characteristics, and/or dimensions as other members of the cybersecurity detection group 62. The detection assessment application 96 may thus instruct or cause the server 24/90 to generate the detection summary 38 of the cybersecurity detection 30, perhaps based on the features/values commonly shared by the group's members. The detection summary 38 explains the very complicated cybersecurity detection 30, based on the features/values commonly shared by the members of the cybersecurity detection group 62.

Membership may be based on the highest similarity 64. The detection assessment application 96 instructs the server 24/90 to compare the similarity 64 to the membership threshold value 66 associated with each cybersecurity detection group 62. There may be instances in which the similarity 64 satisfies multiple, different threshold values 66. Suppose, for example, that the cybersecurity detection 30 has a similarity score of 0.8 to group B and 0.7 similarity score to group C. If both groups B and C have the minimum threshold set of 0.6, then the cybersecurity detection 30 may be a co-member of both groups B and C. The detection assessment application 96, however, may be configured to only assign groupal membership using the highest value of the similarity 64. That is, even though the similarity score of 0.8 exceeds the minimum threshold set of 0.6 for both groups B and C, the detection assessment application 96 may select groupal membership using the highest groupal affinity. In this example, then, because the cybersecurity detection 30 has a highest similarity score of 0.8 to group B, the detection assessment application 96 may assign the cybersecurity detection 30 to only group B.

As FIG. 6 illustrates, the server 24/90 may simplify the detection summary 38. The cybersecurity detection 30 may be complicated to understand. The groupal membership (i.e., the cybersecurity detection group(s) 62) may also be complicated to understand. The detection summary 38 may thus be more complicated than desired. The detection assessment application 96 (such as the model 80), however, may instruct or cause the server 24/90 to simplify the detection summary 38 using plain, ordinary words and phrases. The detection assessment application 96, for example, may instruct the server 24/90 to apply, or interface with, the large language model (or LLM) 68 that generates the natural language version 70 of the detection summary 38 (i.e., the natural language detection summary 38). The large language model 68 thus outputs the natural language detection summary 38 that explains the complicated cybersecurity detection 30, the cybersecurity detection group(s) 62, and/or the detection summary 38 using generalized words and phrases. The natural language detection summary 38 is thus much easier for human users to understand.

The server 24/90 may thus perform the detection assessment 36 as a detection assessment engine. The detection assessment application 96 (perhaps applying the model 80) ingests the cybersecurity detection 30 as an input and generates the groupal membership and/or the detection summary 38 (and/or its natural language version 70) as an output. Again, because the cloud computing environment 22 may receive hundreds or even thousands of daily/weekly cybersecurity detections 30, the preliminary cybersecurity detection assessment 36 quickly automates a grouping/clustering of the cybersecurity detections 30 according to their corresponding similarities 64 to the cybersecurity detection groups 62. The detection assessment application 96 may thus instruct or cause the server 24/90 to generate the detection summary 38 of the cybersecurity detection 30, perhaps based on the features/values commonly shared by the groupal members.

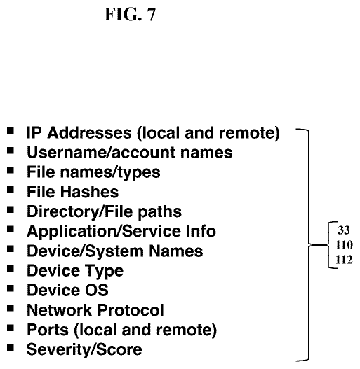

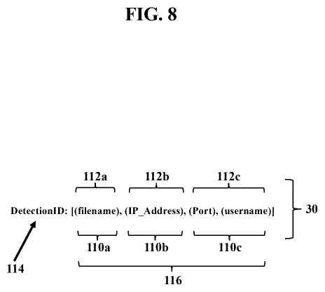

FIGS. 7-8 illustrate more examples of cybersecurity detection grouping. FIG. 7 illustrates some examples of the informational content that may be contained within, or referenced by, the cybersecurity detection 30. The cybersecurity detection 30 may have many data portions, fields, and/or values that describe or reference addresses, files, ports, users, and other information related to the cybersecurity threat 34 detected by the client device 32 (as explained with reference to FIGS. 1-3). The cybersecurity detection 30 may be sourced from many different platforms and/or systems (such as first party cybersecurity providers or third party logging systems). The cybersecurity detection 30 may have differing formats, schemes, and content, depending on the source. Many security information and event management systems (or SIEMs), though, may generate the cybersecurity detection 30 having SIEM data values 110 representing the SIEM fields 112 as illustrated. Although not illustrated, the cybersecurity detection 30 may also have a date/time stamp. Whatever the formatting and content, the digital cybersecurity service 26 may scan and process the cybersecurity detection 30 to extract the data values 110 representing the cybersecurity threat 34. The cybersecurity service 26, for example, may extract SIEM data values 110 representing some or all of the different SIEM fields 112 (such as illustrated in FIGS. 7-8). The cybersecurity service 26, in other words, may extract information from the cybersecurity detection 30 representing expected SIEM data values 110, regardless of the formatting or source. The cybersecurity service 26, for example, may extract information representing IP addresses, user/username, and severity. The cybersecurity service 26, as more examples, may query logging services to retrieve and/or populate any of the SIEM data values 110 representing the SIEM fields 112. If the cybersecurity detection 30 lacks some expected informational content, then the cybersecurity service 26 may assign null or empty values. The cybersecurity service 26 may thus process/scan the cybersecurity detection 30 to read/generate/populate the SIEM fields 112 and their corresponding SIEM data values 110. FIG. 8, for example, illustrates the cybersecurity detection 30 (having unique detection identifier 114) as a small set 116 the SIEM fields 112 and their corresponding SIEM data values 110.

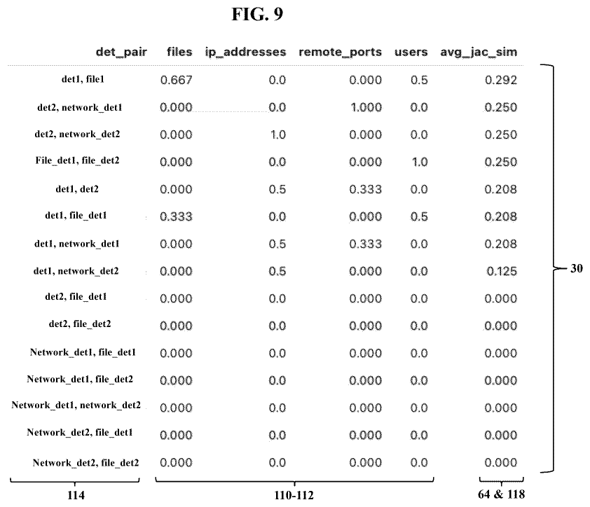

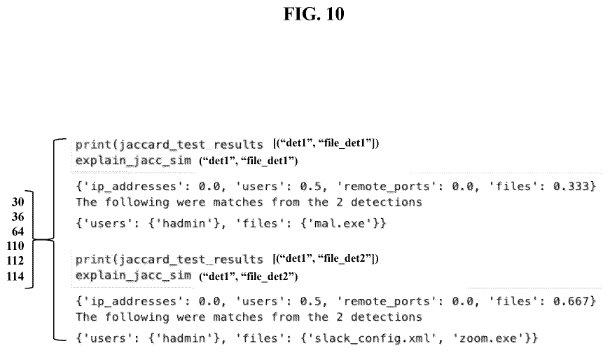

FIGS. 9-10 illustrate examples of the similarity analysis 42. Because the digital cybersecurity service 26 preprocesses the cybersecurity detection 30 (as illustrated with reference to FIGS. 1-6), the cybersecurity detections 30 & 60 have consistent or common formatting and their corresponding, individualized SIEM data values 110 and fields 112 (as explained with reference to FIGS. 7-8). The cybersecurity service 26 may thus compare the cybersecurity detections 30 & 60 and calculate their similarities 64, based on their individual SIEM data values 110. The cybersecurity service 26 (such as the security information and event management system or SIEM), for example, may determine the similarity 64 based on the SIEM data values 110 representing different SIEM fields 112 (such as illustrated in FIGS. 8-9). The detection assessment application 96 (perhaps applying or invoking the model 80) may then instruct or cause the server 24/90 to apply the similarity analysis 42 using the SIEM data values 110 extracted from, and/or logged with, the cybersecurity detection 30. While the server 24/90 and/or the detection assessment 36 may apply whatever similarity analysis 42 is desired to suit performance/cost objectives, FIGS. 9-10 illustrate a Jaccard similarity (such as the similarity 64). The server 24/90 may be instructed to apply the Jaccard similarity technique to every SIEM field 112 and SIEM data value 110 associated with the cybersecurity detection 30. The Jaccard similarity technique determines a similarity coefficient between the SIEM data value 110 and the cybersecurity detection group 62. Moreover, the detection assessment application 96 may then instruct or cause the server 24/90 to generate an aggregated, single similarity score 118 using the individual, field-based Jaccard similarities 64. FIG. 9, for example, illustrates an average Jaccard similarity score 118 for each cybersecurity detection 30.

As FIG. 10 illustrates, the cybersecurity detection assessment 36 thus quickly and elegantly determines the similarity 64 to one or more of the cybersecurity detection groups 62. The similarity 64 may be determined across different types and groups of the cybersecurity detections 30. As the cybersecurity detections 30 can be variable length sets, the detection assessment 36 may use multiset Jaccard similarity to calculate the similarity 64 based on matches of the SIEM data values 110 in each SIEM field set 116. For example, if the cybersecurity detection 30 has (services.exe) and another cybersecurity detection 30 has (services.exe, config.xml), both cybersecurity detections 30 would have the similarity 64 for the partial match similarity score per SIEM field 112. The individual or component field-based similarities 64 may then be aggregated (such as averaged) to determine the single similarity score 118 between a set of cybersecurity detections 30 (i.e., the cybersecurity detection group 62). FIG. 10, for example, illustrates that “file_det2” is more similar to “det1” than “file_det1” is because there is more overlap among sets of the SIEM data values 110. Moreover, FIG. 10 also illustrates how easily explainable the results are. The Jaccard similarity technique, in particular, may be applied to variable length sets 116 of the SIEM data values 110, which would be expected from different SIEM vendors/sources. The Jaccard similarity technique, moreover, is intuitive and explainable for summarizing the cybersecurity detection 30. The Jaccard similarity technique is also flexible, as the similarity 64 may be calculated for each specific category (such as each SIEM fields 112). The Jaccard similarity technique may also be used to aggregate across Jaccard similarity results of each category to generate the single, overall similarity score 118.

The similarity analysis 42, however, may be customized. While the Jaccard similarity technique may be based on exact matches of the SIEM data values 110, the similarity analysis 42 may apply a set intersection/union methodology but have a custom match function (instead of an exact match) when comparing the SIEM data values 110. Each SIEM field 112, as more examples, may have a different similarity analysis 42. The similarity analysis 42, in other words, may be field-specific, so each SIEM field 112 may have its corresponding similarity function. As each SIEM field 112 is independent of other fields, and as each field-based similarity calculation is also independent from each other, the similarity analysis 42 may apply a different, customizable match function per SIEM field 112. Moreover, the aggregation of the similarity scores across the SIEM fields 112 may also be customizable and performed afterwards.

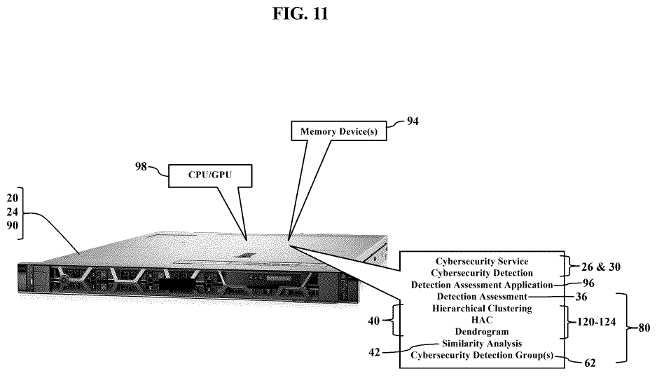

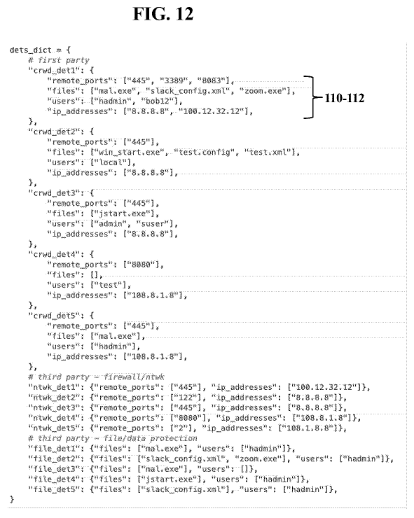

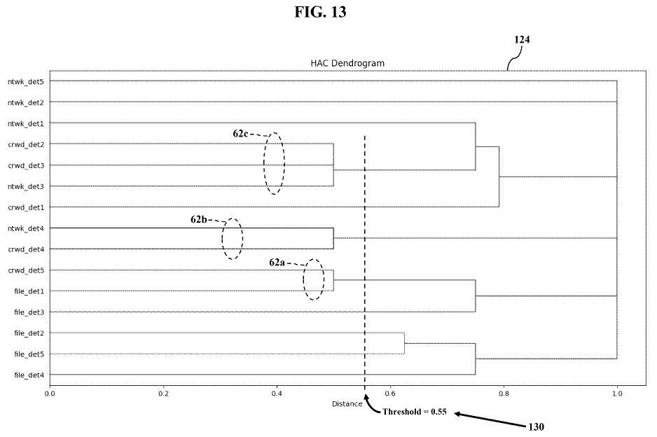

FIGS. 11-14 illustrate more detailed examples of clustering. The detection assessment 36 may use the clustering analysis 40 and the similarity analysis 42 to determine the cybersecurity detection group(s) 62. The detection assessment application 96 (perhaps applying or calling the model 80), for example, may instruct the server 24/90 to apply hierarchical clustering 120 and, in particular, hierarchical agglomerative clustering (or HAC) 122, to group similar cybersecurity detections 30 into a dendrogram 124 (as FIG. 13 best illustrates). The detection assessment application 96, however, may apply other clustering techniques to suit performance and cost objectives. Hierarchical agglomerative clustering (or HAC) 122 iteratively merges similar clusters (such as the cybersecurity detection group(s) 62), perhaps starting with each data point as a separate cluster. HAC 122 thus creates a tree-like structure that shows the relationships between clusters and their hierarchy. An advantage of HAC 122 is not having to pre-define the number of clusters, as is done for k-means.

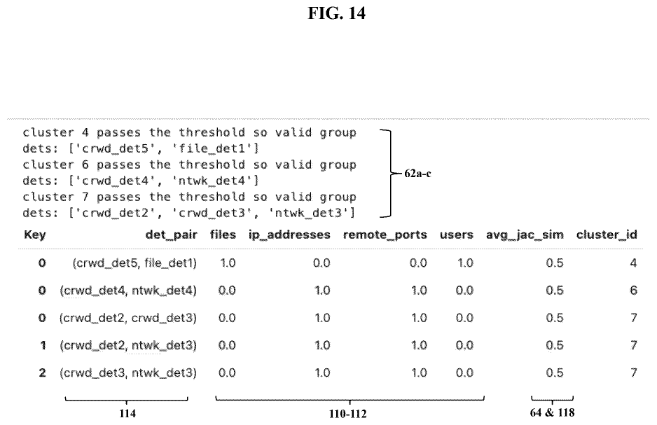

FIGS. 13-14 illustrate the hierarchical agglomerative clustering 122. The clusters (such as the different cybersecurity detection groups 62) may be based on configurable clusteral threshold values 130. In FIG. 13, for example, suppose the clusteral threshold value 130 is initially configured as 0.55 (i.e., the distance along the x-axis of the dendrogram 124). When the clusteral threshold value 130 is 0.55, for example, clusters/groups 62 having distances less than 0.55 may be merged. Clusters having distances ≥0.55, conversely, may be isolated and remain or split. Suppose, for example, the cluster or group 62a consisting of “crwd_det5” and “file_det1” detections both have “hadmin” user and “mal.exe” file as SIEM data values 110 and had an avg_jac_sim=0.5, which is tied with highest pairwise average Jaccard similarity across the whole dataset. Suppose also the cluster or group 62b consisting of “crwd_det4” and “ntwk_det4” both have remote port “8080” and ip_address “108.8.1.8” as SIEM data values 110 and also have avg_jac_sim=0.5. Suppose further that the cluster 62c having three (3) detections (e.g., “crwd_det2,” “crwd_det3,” and “ntwk_det3”) all had remote port “445” and ip_address “8.8.8.8” as SIEM data values 110. FIGS. 13-14 thus illustrate that the results of the three (3) strongest clusters make sense based on matches and the similarity scores between the cybersecurity detections 30 of each cluster (e.g., the corresponding cybersecurity detection group 62). Cross-referencing with the sim_scores across all the cybersecurity detections 30 reveals that these different pairings had the overall highest similarity 64, which is desired and expected.

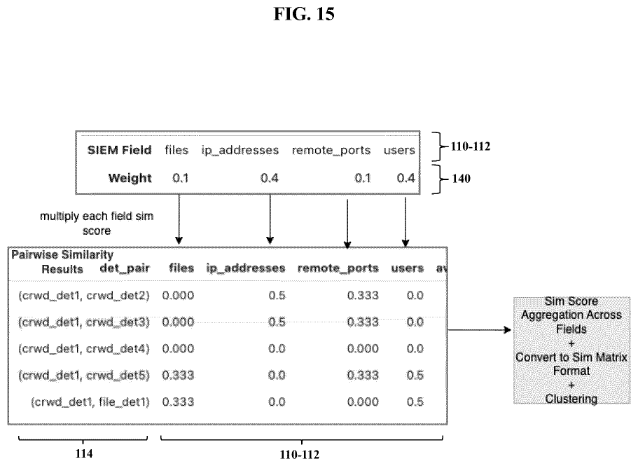

FIG. 15 illustrates examples of SIEM data field weightings. Some SIEM data fields 112, for whatever reason(s), may be more important that other SIEM data fields 112. The IP address and username fields, for example, may sometimes be more revealing of malicious activity and the cybersecurity threats 34 (illustrated in FIG. 1-3). The detection assessment 36 may thus be customized and configured to unequally consider the SIEM data fields 112. Each SIEM data field 112 may thus have a corresponding SIEM data field weight 140 (such as a 0≤weight≤1). The detection assessment 36 may apply the SIEM data field weight 140 when determining the similarity 64 and/or the cybersecurity detection group 62. A user of the detection assessment 36, for example, may merely configure the SIEM data field weights 140 as an input. The detection assessment 36 may then easily apply SIEM data field weights 140 (such as by multiplying a similarity matrix by each SIEM data field weight 140). In FIG. 14, for example, the IP address and username data fields 112 are weighted 4X the files and remote_ports data fields 112. The user may thus emphasize one or more of the SIEM data fields 112 to influence their corresponding similarity and clustering contribution.

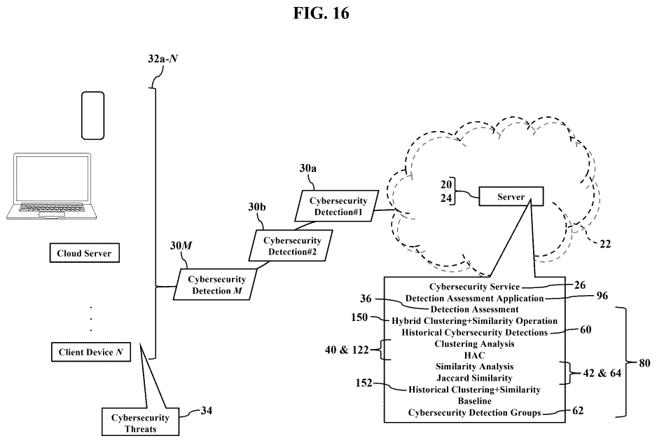

FIGS. 16-18 illustrates examples of streaming-based approaches to clustering+similarity. In these examples, the digital cybersecurity service 26 may apply the cybersecurity detection assessment 36 to the cybersecurity detections 30 streamed from the many client devices 32a-N. Because there may be millions of the client devices 32 sending their cybersecurity detections 30 (as explained with reference to FIGS. 1-2), the server 24 may receive and analyze streams of the cybersecurity detections 30 in real time or in near real time (that is, within seconds or minutes of client detection). The cybersecurity service 26, for example, optimizes data collection from the cybersecurity detections 30 (and any logging services), with as reduced latency time delay as possible, to effectively provide cybersecurity protection from the cybersecurity threats 34. The server 24, for example, may repeatedly perform the detection assessment 36 upon receipt of each cybersecurity detection 30.

A hybrid clustering+similarity operation 150 leverages the clustering analysis 40 and the similarity analysis 42. Again, while other similarity and clustering techniques may be used, FIGS. 16-18 again illustrate examples using the Jaccard similarity 64 and the hierarchical agglomerative clustering (or HAC) 122. The detection assessment application 96, for example, may instruct the server 24 to perform the hybrid clustering+similarity operation 150 that clusters/groups 62 the cybersecurity detections 30 in real time or in near real time, based on non-streaming, historical detection assessments 36 (e.g., clustering+similarity) conducted within a previous window of time. For example, when the server 24 receives a new/current (e.g., real time) cybersecurity detection 30, the server 24 may compare the cybersecurity detection 30 to the historical cybersecurity detections 60 assessed within the past week, month, or other historical time period. Suppose, for example, that the detection assessment application 96 causes the server 24 to generate and store a historical clustering+similarity baseline 152. The historical clustering+similarity baseline 152 describes or represents the cybersecurity detection groups 62 determined, perhaps in a non-streaming fashion, using the Jaccard similarity 64 and the hierarchical agglomerative clustering 122 over the past X number of days (as explained with reference to FIGS. 1-15).

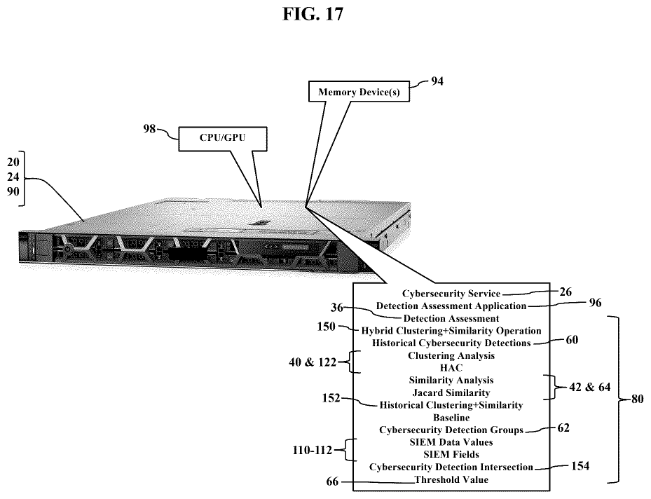

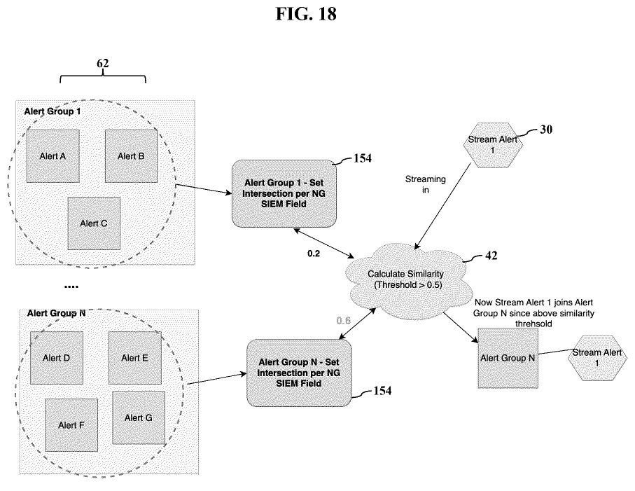

FIGS. 17-18 further illustrate examples of the hybrid clustering+similarity operation 150. When the server 24 (again illustrated as the rack server 90) receives the new cybersecurity detection 30 (i.e., having a current/recent time stamp), the detection assessment application 96 instructs the server 24/90 to calculate the Jaccard similarity 64 between the new cybersecurity detection 30 and every cybersecurity detection group 62 represented by the historical clustering+similarity baseline 152. However, in order to calculate the Jaccard similarity 64 between the new cybersecurity detection 30 and the cybersecurity detection groups 62, the detection assessment application 96 instructs the server 24/90 to elegantly determine a cybersecurity detection intersection 154. The server 24, for example, may determine the cybersecurity detection intersection 154 between the historical cybersecurity detections 60 as members within the same cybersecurity detection group 62 (such as formed by the hierarchical agglomerative clustering (or HAC) 122 representing the historical clustering+similarity baseline 152). That is, the detection assessment application 96 may first instruct the server 24/90 to determine the cybersecurity detection intersection 154 according to

$${⋂}_{i = 1}^{n} {D}_{i} ,$$

where Dᵢ represents each historical cybersecurity detection 60 associated with one of the cybersecurity detection groups 62, and the cybersecurity detection intersection 154 is repeatedly taken over the n members in the cybersecurity detection group 62. The cybersecurity detection intersection 154 thus takes all the membership historical cybersecurity detections 60 within each already existing/historical cybersecurity detection group 62 and, for each SIEM field 112, the server 24 determines the SIEM field values set intersection across the historical cybersecurity detections 60 within the cybersecurity detection group 62. The resultant cybersecurity detection intersection 154 for the cybersecurity detection group 62 is the set of intersecting SIEM field values 110 for each SIEM field 112.

The hybrid clustering+similarity operation 150 may apply the Jaccard similarity 64. For example, when the server 24 receives the incoming/streaming new cybersecurity detection 30, the detection assessment application 96 instructs the server 24/90 to calculate the Jaccard similarity 64 between the new cybersecurity detection 30 and the cybersecurity detection intersection 154 for the cybersecurity detection group 62. That is, for each SIEM field 112 in the new cybersecurity detection 30, the server 24 compares each corresponding SIEM data value 110 to the corresponding SIEM data value 110 in the cybersecurity detection intersection 154 for the cybersecurity detection group 62 using the Jaccard similarity 64. The server 24 thus determines the Jaccard similarity score per SIEM field 112. The detection assessment application 96 may then cause the server 24/90 to generate the aggregated, single similarity score 118. Again, while other scoring schemes may be used, for simplicity, the server 24/90 generates an average across all the SIEM fields 112 of the new cybersecurity detection 30 to determine single, average Jaccard similarity value between the new cybersecurity detection 30 and each cybersecurity detection group 62 associated with the historical clustering+similarity baseline 152.

The hybrid clustering+similarity operation 150 may then select a best cluster match. The hybrid clustering+similarity operation 150 determines the cybersecurity detection group 62 (associated with the historical clustering+similarity baseline 152) whose membership traits best represent the incoming/streaming new cybersecurity detection 30. Again, while other scoring/matching schemes may be used, for simplicity, the detection assessment application 96 may instruct the server 24/90 to select the cluster/group 62 having the highest average Jaccard similarity 64 for the new cybersecurity detection 30. Moreover, the detection assessment application 96 may instruct the server 24/90 to compare the highest average Jaccard similarity 64 to the cybersecurity detection group membership threshold value 66. The cybersecurity detection group membership threshold value 66, for example, represents the minimum average Jaccard similarity 64 that is required for membership to the corresponding cybersecurity detection group 62. The different cybersecurity detection group 62 (associated with the historical clustering+similarity baseline 152), in other words, may have differing membership similarity requirements, so each cybersecurity detection group 62 may have its own, corresponding cybersecurity detection group membership threshold value 66. So, if the highest average Jaccard similarity 64 equals or exceeds the cybersecurity detection group membership threshold value 66 associated with the corresponding cybersecurity detection group 62, then the detection assessment application 96 instructs the server 24/90 to add the incoming/streaming new cybersecurity detection 30 as a member of the cybersecurity detection group 62. If, however, the highest average Jaccard similarity 64 is less than the cybersecurity detection group membership threshold value 66, then the detection assessment application 96 declines to add the incoming/streaming new cybersecurity detection 30 as a member of the cybersecurity detection group 62. Indeed, the detection assessment application 96 may be optionally configured to create a new cluster/group 62 with only that new cybersecurity detection 30 as a member. Moreover, the detection assessment application 96 may be optionally configured to wait for the next retraining of the hybrid clustering+similarity operation 150 to create fresh new clusters. Regardless, the cybersecurity detection group membership threshold value 66 may be a parameter that is tuned as part of model development and analysis work before the machine learning model 80 is deployed.

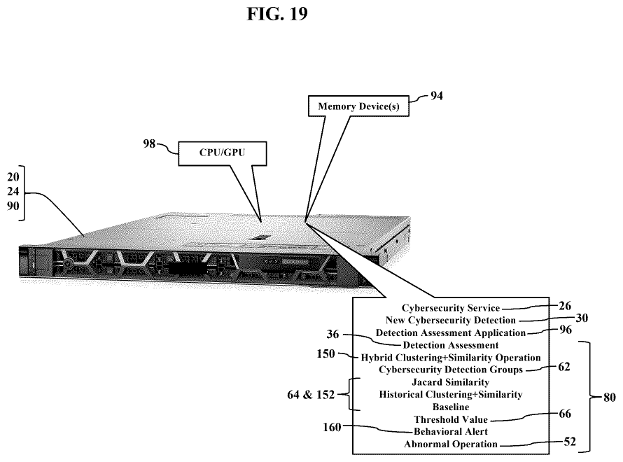

FIG. 19 illustrates more examples of the hybrid clustering+similarity operation 150. The hybrid clustering+similarity operation 150 assesses the incoming/streaming new cybersecurity detection 30 for its groupal association. Sometimes, however, the highest average Jaccard similarity 64 (associated with the new cybersecurity detection 30) may fail to satisfy the cybersecurity detection group membership threshold value(s) 66. Simply put, the new cybersecurity detection 30 lacks similarity to the cybersecurity detection groups 62 associated with the historical clustering+similarity baseline 152. Because the new cybersecurity detection 30 is dissimilar to the historical cybersecurity detection groups 62, the detection assessment application 96 may be optionally configured to generate a behavioral alert 160. The new cybersecurity detection 30 represents some client computer activity, behavior, and/or context that is the abnormal operation 52. The detection assessment application 96 may thus instruct the server 24 to send the behavioral alert 160 to a downstream process for further investigation/review.

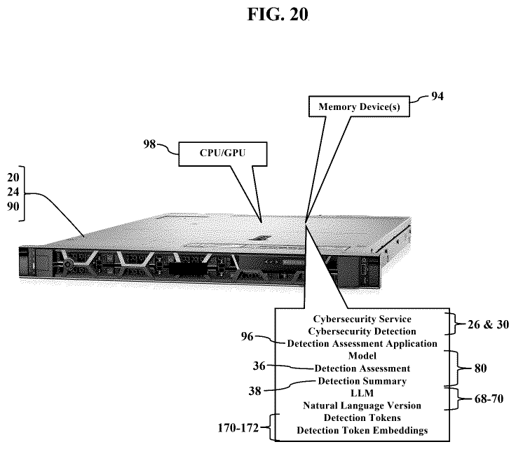

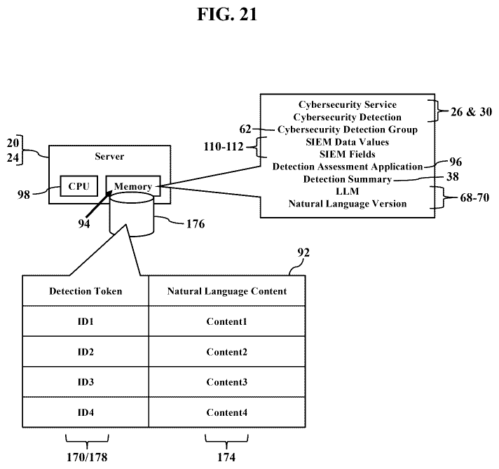

FIGS. 20-21 illustrate more detailed examples of the detection summary 38. The cybersecurity detection 30 represents much complicated data (such as the SIEM fields 112 and their corresponding SIEM data values 110, as explained with reference to FIGS. 7-18). Moreover, each cybersecurity detection group 62 may also represent complicated data. So, once the hybrid clustering+similarity operation 150 determines the group membership of the incoming/streaming new cybersecurity detection 30 (as explained with reference to FIGS. 1-18), the cybersecurity service 26 may generate the simplified detection summary 38 using plain, ordinary words and phrases. The detection assessment application 96, for example, may instruct the server 24/90 to apply, or to interface with, the large language model (or LLM) 68 that generates the natural language version 70 of the detection summary 38 (i.e., the natural language detection summary 38). The large language model 68 thus outputs the natural language detection summary 38 that explains the complicated cybersecurity detection 30 and/or the cybersecurity detection group 62 using generalized words and phrases. The natural language detection summary 38 is thus much easier for human users to understand.

The large language model 68, for example, may tokenize the data associated with the new cybersecurity detection 30 and the cybersecurity detection group 62. In FIG. 20, for example, the detection assessment application 96 and/or the large language model 68 may include instructions or code that cause the server 24 (again illustrated as the rack server 90) to perform operations for generating detection tokens 170. The large language model 68 may then be trained using the detection tokens 170. The large language model 68, for example, may be trained with tokenized textual training data representing the SIEM fields 112, SIEM data values 110, and/or the cybersecurity detection groups 62. The large language model 68 is thus trained to analyze patterns and semantic relationships between the detection tokens 170. Moreover, server 24 may further generate detection token embeddings 172 that represent the semantic relationships between the detection tokens 170. Each detection token embedding 172 is assigned to a corresponding one of the detection tokens 170, for example, based on how commonly the corresponding detection token 170 is used together with, or in similar contexts to, the other detection tokens 170. After training, the large language model 68 may use those patterns and relationships to generate a sequence of output tokens based on the new cybersecurity detection 30 and the cybersecurity detection group 62.

FIG. 21 illustrates natural language textual content 174. The server 24 generates the natural language detection summary 38. Once the server 24 receives the real time cybersecurity detection 30 and determines its membership (if any) to the cybersecurity detection group(s) 62 (as this disclosure previously explained), the server 24, for example, may tokenize the data associated with the cybersecurity detection 30 and the cybersecurity detection group 62. The detection tokens 170, for example, may represent the SIEM fields 112, their corresponding SIEM data values 110, and other words, character sets, or combinations of words and punctuation represented by the cybersecurity detection 30 and the cybersecurity detection group(s) 62. Moreover, each detection token 170 may also have a predetermined relationship to its corresponding natural language explanation, meaning, definition, or other textual content 174. The cybersecurity service 26 may thus maintain a detection token-to-text database 176 that is locally or remotely accessible to the server 24. The detection token-to-text database 176, for example, may have columnar/row/tabular database entries that map, relate, or otherwise associate different detection tokens 170 to their corresponding natural language textual content 174. The detection token-to-text database 176 may thus map different detection token identifiers 178 to their corresponding natural language textual content 174. When the server 24 generates the detection tokens 170 (such as by tokenizing the SIEM fields 112, their corresponding SIEM data values 110, and/or the cybersecurity detection group 62), the server 24 may query the detection token-to-text database 176 for a unique detection token identifier 178 associated with each detection token 170. The server 24 may then retrieve the corresponding natural language textual content 174 that corresponds to the detection token identifier 178 (and thus also to the corresponding detection token 170, and the corresponding SIEM fields 112, SIEM data values 110, and/or the cybersecurity detection group 62). So, as the server 24 generates sequences of the detection tokens 170 (and thus sequences of detection token identifiers 178), the server 24 identify and combine the natural language textual content 174 associated with each detection token 170. The server 24 may thus combine/string/stack or otherwise generate the natural language output 70 based on the natural language textual content 174 associated with each detection token 170.

The natural language detection summary 38 simply explains the real time cybersecurity detection 30 and its group membership traits. The natural language detection summary 38, for example, explains the complicated cybersecurity detection 30 and its common group membership features/traits (associated with the cybersecurity detection group 62). The natural language detection summary 38, in other words, explains the complicated cybersecurity detection 30 using generalized words and phrases. The natural language detection summary 38 also explains the complicated cybersecurity detection group 62 using generalized words and phrases. The natural language detection summary 38 is thus much easier for human users to understand.

As one may now understand, the natural language detection summary 38 is highly effective and useful in the cybersecurity service 26. The natural language detection summary 38 summarizes and contextualizes raw alerts (i.e., the incoming cybersecurity detections 30) in near real time. The natural language detection summary 38 provides a fast and simple explanation that greatly reduces human time and effort. The natural language detection summary 38 provides useful information on cybersecurity detections 30 within a cybersecurity detection/alert group 62. Simply put, the hybrid clustering+similarity operation 150 does the heavy lifting in terms of a lot of data calculations and creates subsets of alerts/detections 30 in the groups 62. In other words, data regarding the cybersecurity detection group 62 is small enough overall in data size to fit into an LLM prompt, so the groups 62 may be used to explain and summarize cybersecurity detections 30. The natural language detection summary 38 is much easier for an end user to understand the alert groupings 62.

The detection assessment 36 need not use machine learning and/or artificial intelligence. As the detection assessment 36 utilizes the clustering analysis 40 and the similarity analysis 42, the detection assessment 36 may take the cybersecurity detection intersections 154 of the different SIEM fields/values 112/110 and provide those exact similarity matches, along with associated similarity metrics, to the end user in a user-friendly format, which can help them quickly understand and contextualize the alert groups 62. This scheme remains a powerful and useful cybersecurity tool, even if machine learning and/or artificial intelligence is not implemented.

Computer functioning is greatly improved. Malicious software can ruin computer operations. The server 24 quickly identifies and groups the cybersecurity detections 30 for much faster cybersecurity services. Moreover, the server 24 may quickly identify non-conforming suspicious/malicious abnormal operations 52 to minimize damage to the client devices 32. Because the detection assessment application 96 may utilize the ML/AI model 80, the cybersecurity service 26 is very fast and very simple to execute. The server 24 need merely compare the cybersecurity detections 30 to the ranges/values referenced by the cybersecurity detection groups 62. The ML/AI model 80 consumes little space (in bits/bytes) in the memory device 94. Moreover, because similarity comparisons are the simple and quick cybersecurity detection intersections 154, the hardware processor 98 requires less cycles and less time to group and assess the cybersecurity detections 30. Computer resources are reduced, and less electrical power is required to test for groupal membership. The cybersecurity service 26 is thus very fast and very simple, allowing the server 24 to quickly assess the thousands or millions of cybersecurity threats/detections 30. The cybersecurity service 26 thus greatly improves computer functioning of the server 24 when detecting abnormal client operations 52.

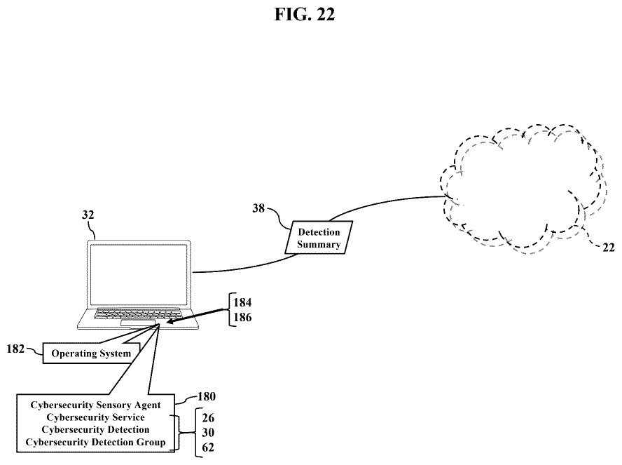

FIG. 22 illustrates examples of host monitoring. Here the detection assessment 36 may be locally performed by the client device 32. When the client device 32 subscribes to the cybersecurity service 26, for example, the client device 32 may download and install a cybersecurity sensory agent 180. The cybersecurity sensory agent 180 monitors the client device 32. The cybersecurity sensory agent 180 interfaces with the operating system 182 executed by the client device 32. The cybersecurity sensory agent 180 is a software application or program code stored in the memory device 184 of the client device 32 and executed by the hardware processor 186 operating within the client device 32. The cybersecurity sensory agent 180 may thus have permissions to monitor kernel-level client events/activities/behaviors and/or user-mode client events/activities/behaviors associated with the client device 32. Should the cybersecurity sensory agent 180 detect suspicious activity, the cybersecurity sensory agent 180 cooperates with the operating system to generate and to locally assess the cybersecurity detection 30. The endpoint cybersecurity sensory agent 180, in other words, may locally conduct and provide the cybersecurity service 26 with little, or no, reliance on the cloud computing environment 22. The cybersecurity sensory agent 180 may apply the clustering analysis 40, the similarity analysis 42, and the cybersecurity detection intersection 154 to determine the groupal membership to the groups 62. The cybersecurity sensory agent 180 may then report the groupal membership, and/or the detection summary 38, to the cloud computing environment 22

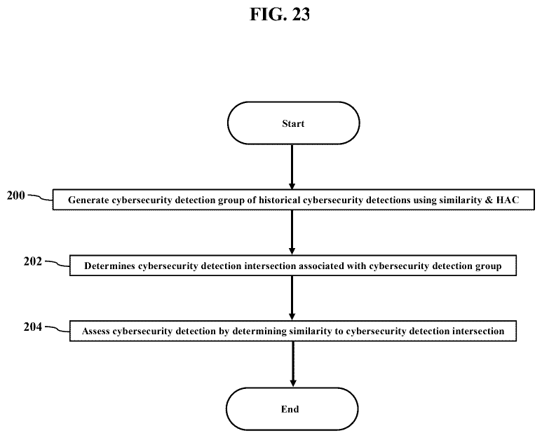

FIG. 23 illustrates examples of a method or operations executed by the computer system 20 that assesses the cybersecurity detection 30. The computer system 20 generates the cybersecurity detection group 62 of the historical cybersecurity detections 60 using the similarity 64 and the hierarchical agglomerative clustering (or HAC 122) (Block 200). The computer system 20 determines the cybersecurity detection intersection 154 associated with the cybersecurity detection group 62 (Block 202). The computer system 20 assesses the cybersecurity detection 30 by determining the similarity 64 of the cybersecurity detection 30 to the cybersecurity detection intersection 154 associated with the cybersecurity detection group 62 (Block 204).

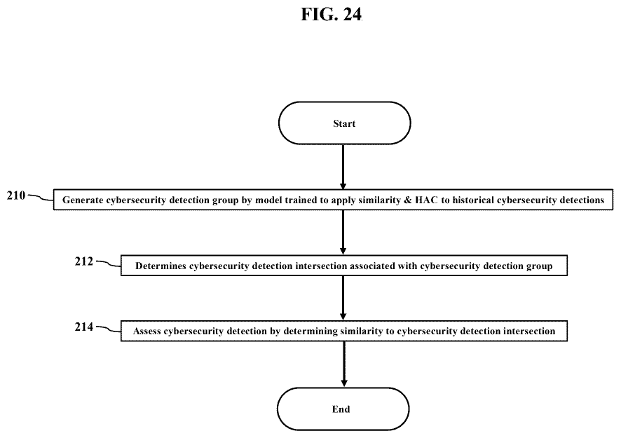

FIG. 24 illustrates examples of another method or operations that assess the cybersecurity detection 30. The cybersecurity detection group 62 is generated by the ML/AI model 80 trained to apply the similarity 64 and the hierarchical agglomerative clustering (or HAC 122) to the historical cybersecurity detections 60 (Block 210). The cybersecurity detection intersection 154 is determined (Block 212) and the cybersecurity detection 30 is assessed by determining the similarity 64 of the cybersecurity detection 30 to the cybersecurity detection intersection 154 (Block 214).

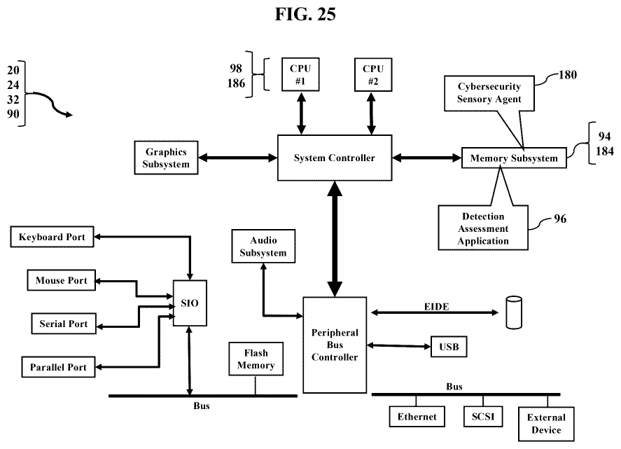

FIG. 25 illustrates more detailed examples of the operating environment. FIG. 25 is a more detailed block diagram illustrating the computer system 20 and the client device 32. The detection assessment application 96 and/or the endpoint cybersecurity sensory agent 180 is stored in the memory subsystem or device 94/184. One or more of the hardware processors 98/186 communicate with the memory subsystem or device 94/184 and execute the detection assessment application 96 and/or the endpoint cybersecurity sensory agent 180. Examples of the memory subsystem or device 94/184 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and other read/write memory technology. Because the computer system 20 and the client device 32 is/are known to those of ordinary skill in the art, no detailed explanation is needed.

The computer system 20 and the client device 32 may have other embodiments. This disclosure mostly discusses the computer system 20 as the server 24 and the client device 32 as a laptop computer. The cybersecurity service 26, however, may be easily adapted to other stationary or mobile computing examples, such as a desktop computer, a tablet computer, a smartwatch, and a network switch/router. The cybersecurity service 26 may also be easily adapted to other embodiments of smart devices, such as a television, an audio device, a remote control, and a recorder. The cybersecurity service 26 may also be easily adapted to still more smart appliances, such as washers, dryers, and refrigerators. Indeed, as cars, trucks, and other vehicles grow in electronic usage and in processing power, the cybersecurity service 26 may be easily incorporated into a vehicular controller.

The above examples of the cybersecurity service 26 may be applied regardless of the networking environment. The cybersecurity service 26 may be easily adapted to stationary or mobile devices having wide-area networking (e.g., 4G/LTE/5G/6G/7G cellular), wireless local area networking (WI-FI®), near field, and/or BLUETOOTH® capability. The cybersecurity service 26 may be applied to stationary or mobile devices utilizing any portion of the electromagnetic spectrum and a signaling standard (such as the IEEE 802 family of standards, GSM/CDMA/TDMA or other cellular standard, and/or the ISM band). The cybersecurity service 26, however, may be applied to a processor-controlled device operating in the radio-frequency domain and/or the Internet Protocol (IP) domain. The cybersecurity service 26 may be applied to a processor-controlled device utilizing a distributed computing network, such as the Internet (sometimes alternatively known as the “World Wide Web”), an intranet, a local-area network (LAN), and/or a wide-area network (WAN). The cybersecurity service 26 may be applied to a processor-controlled device utilizing power line technologies, in which signals are communicated via electrical wiring. Indeed, the many examples may be applied regardless of physical componentry, physical configuration, or communications standard(s).

The cybersecurity service 26 may utilize a processing component, configuration, or system. For example, the cybersecurity service 26 may be easily adapted to a desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, or other manufacturer. The cybersecurity service 26 may even use multiple central processing units or chipsets, which could include distributed processors or parallel processors in a single machine or multiple machines. The central processing unit or chipset can be used in supporting a virtual processing environment. The central processing unit or chipset could include a state machine or logic controller. When any of the central processing units or chipsets execute instructions to perform “operations,” this could include the central processing unit or chipset performing the operations directly and/or facilitating, directing, or cooperating with another device or component to perform the operations.

The cybersecurity service 26 may use packetized communications. When the computer system 20 or the client device 32 communicates via communications networks, information may be collected, sent, and retrieved. The information may be formatted or generated as packets of data according to a packet protocol (such as the Internet Protocol). The packets of data contain bits or bytes of data describing the contents, or payload, of a message. A header of each packet of data may be read or inspected and contain routing information identifying an origination address and/or a destination address.

The cybersecurity service 26 may utilize a signaling standard. The computer system 20, the client device 32, and/or the cloud computing environment 22 may mostly use wired networks to interconnect network members. However, the computer system 20, the client device 32, and/or the cloud computing environment 22 may utilize other communications devices using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or a variant of the GSM/CDMA/TDMA signaling standard. The cybersecurity service 26 may also utilize other standards, such as the I.E.E.E. 802 family of standards, the Industrial, Scientific, and Medical band of the electromagnetic spectrum, BLUETOOTH®, low-power or near-field, and other standard or value.

The cybersecurity service 26 may be physically embodied on or in a computer-readable storage medium. This computer-readable medium, for example, may include CD-ROM, DVD, tape, cassette, floppy disk, optical disk, USB flash memory drive, memory card, memory drive, and large-capacity disks. This computer-readable medium, or media, could be distributed to end-subscribers, licensees, and assignees. A computer program product comprises processor-executable instructions for assessing the cybersecurity detections 30, as the above paragraphs explain.

The diagrams, schematics, illustrations, and the like represent conceptual views or processes illustrating examples of prioritizing the cybersecurity detections 30. The functions of the various elements shown in the figures may be provided through the use of dedicated hardware as well as hardware capable of executing instructions. The hardware, processes, methods, and/or operating systems described herein are for illustrative purposes and, thus, are not intended to be limited to a particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that assesses a cybersecurity detection, comprising:
generating, by the computer system, a cybersecurity detection group of historical cybersecurity detections using similarity and hierarchical agglomerative clustering;
determining, by the computer system, a cybersecurity detection intersection associated with the cybersecurity detection group; and
assessing, by the computer system, the cybersecurity detection by determining the similarity of the cybersecurity detection to the cybersecurity detection intersection associated with the cybersecurity detection group.

2. The method of claim 1, wherein the determining of the cybersecurity detection intersection further comprises set intersecting field values associated with the historical cybersecurity detections.

3. The method of claim 1, further comprising determining an aggregated similarity score representing the similarity of the cybersecurity detection to the cybersecurity detection intersection.

4. The method of claim 1, further comprising determining similarities between fields associated with the cybersecurity detection to the fields associated with the cybersecurity detection intersection.

5. The method of claim 4, further comprising determining an aggregated similarity score representing the similarities between the fields.

6. The method of claim 4, further comprising determining an average similarity score representing the similarities between the fields.

7. The method of claim 1, further comprising comparing the similarity to a threshold value associated with the cybersecurity detection group.

8. The method of claim 7, wherein in response to the similarity satisfying the threshold value, then further comprising associating the cybersecurity detection as a member of the cybersecurity detection group.

9. The method of claim 7, further comprising determining the similarity fails to satisfy the threshold value associated with the cybersecurity detection group.

10. The method of claim 9, wherein in response to the determining that the similarity fails to satisfy the threshold value, further comprising generating a behavioral alert indicating the cybersecurity detection represents abnormal operation.

11. A computer system that assesses a cybersecurity detection, comprising:
at least one central processing unit; and
at least one memory device storing instructions that, when executed by the at least one central processing unit, perform operations, the operations comprising:
generating a cybersecurity detection group by a machine learning model trained to apply similarity and hierarchical agglomerative clustering to historical cybersecurity detections;
determining a cybersecurity detection intersection associated with the cybersecurity detection group generated by the machine learning model trained to apply the similarity and the hierarchical agglomerative clustering to the historical cybersecurity detections; and
assessing the cybersecurity detection by determining the similarity of the cybersecurity detection to the cybersecurity detection intersection associated with the cybersecurity detection group.

12. The computer system of claim 11, wherein the operations further comprise set intersecting field values associated with the historical cybersecurity detections.

13. The computer system of claim 11, wherein the operations further comprise determining similarities between fields associated with the cybersecurity detection to the fields associated with the cybersecurity detection intersection.

14. The computer system of claim 13, wherein the operations further comprise determining an aggregated similarity score representing the similarities between the fields associated with the cybersecurity detection to the fields associated with the cybersecurity detection intersection.

15. The computer system of claim 14, wherein the operations further comprise determining an average similarity score representing the similarities between the fields.

16. The computer system of claim 15, wherein the operations further comprise comparing the average similarity score to a threshold value associated with the cybersecurity detection group.

17. The computer system of claim 16, wherein the operations further comprise:
associating the cybersecurity detection as a member of the cybersecurity detection group in response to the average similarity score satisfying the threshold value; and
generating a behavioral alert indicating the cybersecurity detection represents an abnormal operation in response to the average similarity score failing to satisfy the threshold value.

18. A memory device storing instructions that, when executed by at least one central processing unit, perform operations that assesses a cybersecurity detection, comprising:
generating a cybersecurity detection group by a machine learning model trained to apply similarity and hierarchical agglomerative clustering to historical cybersecurity detections;
determining a cybersecurity detection intersection between the historical cybersecurity detections associated with the cybersecurity detection group generated by the machine learning model trained to apply the similarity and the hierarchical agglomerative clustering to the historical cybersecurity detections; and
assessing the cybersecurity detection by determining the similarity of the cybersecurity detection to the cybersecurity detection intersection associated with the cybersecurity detection group.

19. The memory device of claim 18, wherein the operations further comprise comparing the similarity to a threshold value associated with the cybersecurity detection group.

20. The memory device of claim 19, wherein the operations further comprise:
associating the cybersecurity detection as a member of the cybersecurity detection group in response to the similarity satisfying the threshold value; and
generating a behavioral alert indicating the cybersecurity detection represents an abnormal operation in response to the similarity failing to satisfy the threshold value.
